(19) United States
(12) Patent Application Publication
(10) Pub. No.: US 2010/0279613 A1
(43) Pub. Date: Nov. 4, 2010

(54) METHOD FOR ESTABLISHING A BLUETOOTH CONNECTION

(75) Inventor: YU-LUN LI, Taoyuan (TW)

Correspondence Address: Altis Law Group, Inc.;ATTN: Steven Reiss, 288 SOUTH MAYO AVENUE, CITY OF INDUSTRY, CA, 91789, US

(73) Assignee: FOXCONN COMMUNICATION TECHNOLOGY CORP., Taoyuan County (TW)

(21) Appl. No.: 12/619,767

(22) Filed: Nov. 17, 2009

(30) Foreign Application Priority Data
Apr. 29, 2009 (CN) 200910301978.0

(51) Int. Cl. H04B 7/00

(52) U.S. Cl. 455/41.3; 340/10.1

(57) ABSTRACT

A method for establishing a Bluetooth (BT) connection between a first electronic device and a second electronic device include acquiring an address of a first BT device of the first electronic device, and writing the address into a RFID tag of the stylus through a connection between the first electronic device and a stylus. The method further include reading the address from the RFID tag by the second electronic device, and establishing a BT connection between the second electronic device and the first electronic device according to the address.

### BACKGROUND

1. Technical Field

Embodiments of the present disclosure relate to Bluetooth (BT) connections, and more particularly to a method for establishing a BT connection between electronic devices.

2. Description of Related Art

Many electronic devices are configured with BT devices. Such electronic devices may establish BT connections to transmit data freely. If a first electronic device wants to establish a BT connection with a second electronic device, the first electronic device needs to know an address of a BT device of the second electronic device. However, if there are multiple electronic devices including BT devices around the first electronic device and the second electronic device, it is inconvenient for people to choose a correct address of the BT device of the second electronic device. That is, it is time consuming to establish a BT connection between two target electronic devices.

What is needed, therefore, is an improved method for establishing a BT connection between the electronic devices.

### BRIEF DESCRIPTION OF THE DRAWINGS

FIG. 1 is a block diagram of a first embodiment of a BT connection between a first electronic device and a second electronic device.

FIG. 2 is a flowchart of the first embodiment of a method for establishing the BT connection between the first electronic devices and the second electronic device of FIG. 1.

FIG. 3 is a block diagram of a second embodiment of a BT connection between the first electronic device and the second electronic device.

FIG. 4 is a flowchart of the second embodiment of a method for establishing the BT connection between the first electronic devices and the second electronic device of FIG. 3.

### DETAILED DESCRIPTION

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

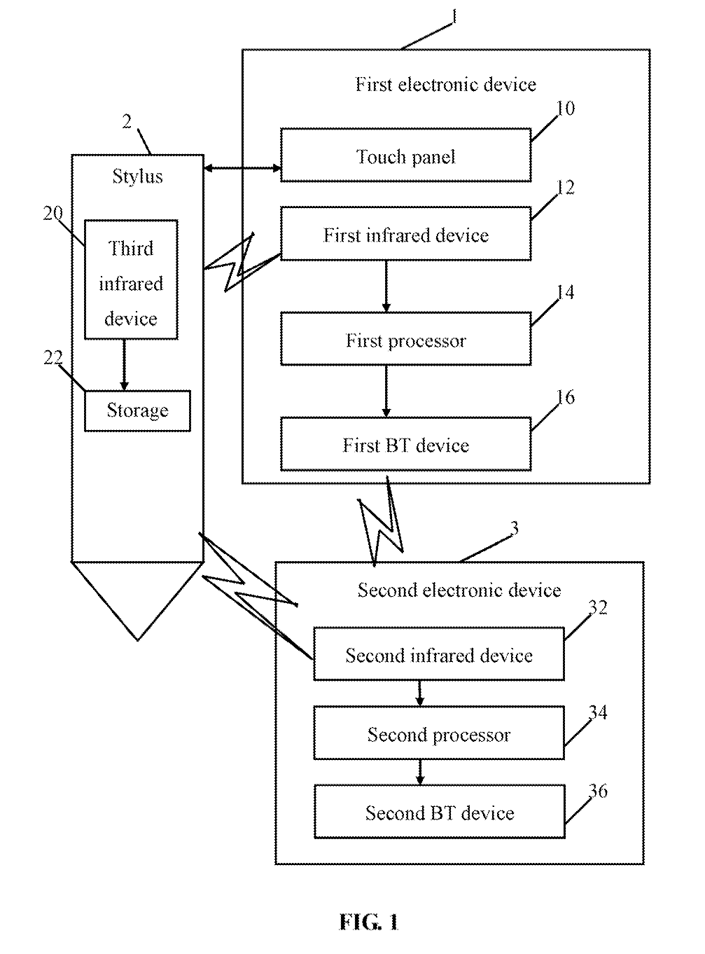

FIG. 1 is a block diagram of a first embodiment of a Bluetooth (BT) connection between a first electronic device 1 and a second electronic device 3. When a BT connection between the second electronic device 3 and the first electronic device 1 needs to be established, the second electronic device 3 acquires an address of a first BT device 16 of the first electronic device 1. According to the embodiment, the second electronic device 3 acquires the address of the first BT device 16, and then establishes the BT connection with the first electronic device 1 conveniently, especially when there are other connectable BT devices around the second electronic device 3.

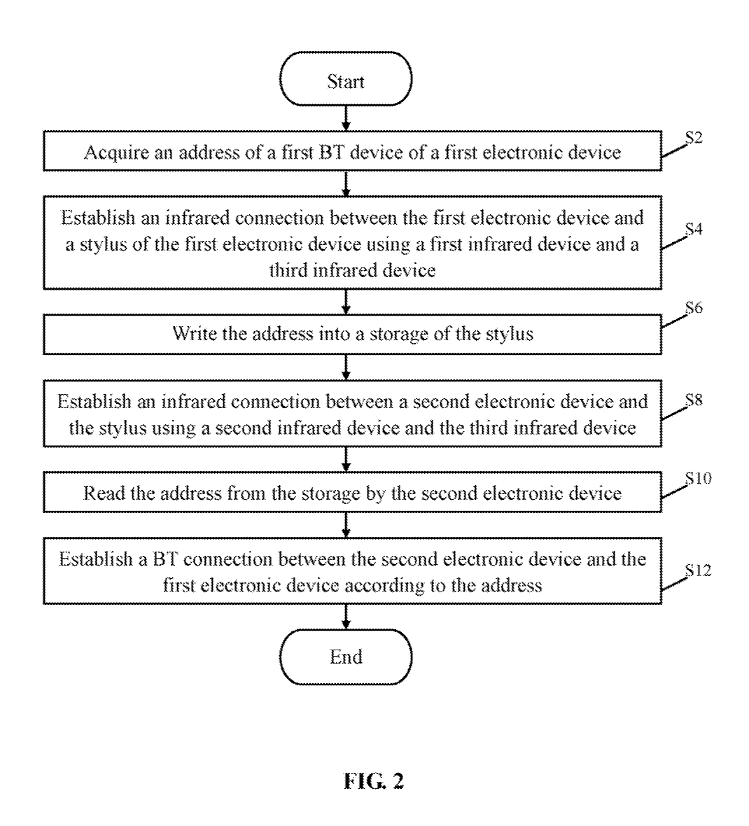

The first electronic device 1 includes a touch panel 10, a stylus 2, a first infrared device 12, a first processor 14, and a first BT device 16. The stylus 2 includes a third infrared device 20, and a storage 22. The second electronic device 3 includes a second infrared device 32, a second processor 34, and a second BT device 36. Details of operations on establishing the BT connection between the above mentioned electronic devices will be provided in FIG. 2.

In one embodiment, the first electronic device 1 and the second electronic device 3 may be mobile phones, personal digital assistants, handheld computers, or any other kind of computing devices. The first processor 14 and the second processor 34 execute one or more computerized operations of the first electronic device 1 and the second electronic device 3, to provide functions of the first electronic device 1 and the second electronic device 3.

FIG. 2 is a flowchart of the first embodiment of a method for establishing the BT connection between the first electronic devices 1 and the second electronic device 3 of FIG. 1.

In block S2, the first processor 14 acquires an address of the first BT device 16 of the first electronic device 1. Each BT device has an unique address. The address of each BT device may be expressed as “XX:XX:XX:XX:XX:XX,” such as “00:16:53:04:F1:B3,” for example.

In block S4, the first electronic device 1 establishes an infrared connection with the stylus 2 using the first infrared device 12 and the third infrared device 20. The infrared connection may be used to transmit data, such as the address of the first BT device 16, for example.

In block S6, the processor 14 stores the address of the first BT device 16 into the storage 22 of the stylus 2. In one embodiment, the storage 22 may be a register or any other kind of storage device.

In block S8, the second electronic device 3 establishes an infrared connection with the stylus 2 using the second infrared device 32 and the third infrared device 20.

In block S10, the second processor 34 reads the address of the first BT device 16 from the storage 22 of the stylus 2.

In block S12, the second electronic device 3 establishes a BT connection with the first electronic device 1 using the second BT device 36 and the first BT device 16 according to the address of the first BT device 16.

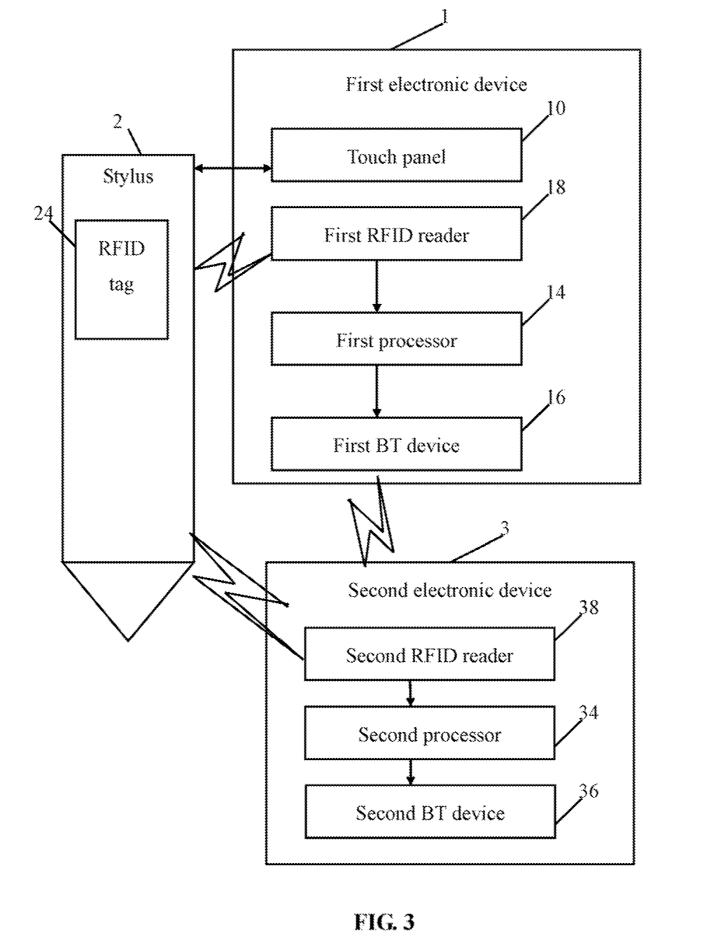

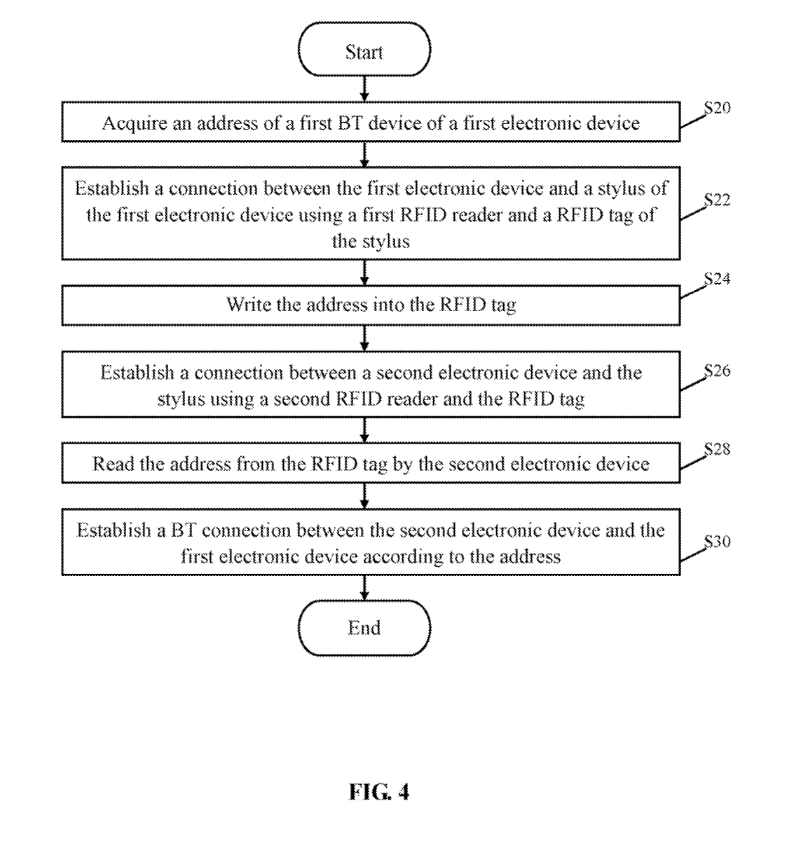

FIG. 3 is a block diagram of a second embodiment of the BT connection between the first electronic device 1 and the second electronic device 3. According to the embodiment, the first electronic device 1 may include the touch panel 10, a first radio frequency identification (RFID) reader 18, the first processor 14, and the first BT device 16. The stylus 2 may include a RFID tag 24. The second electronic device 3 may include a second RFID reader 38, the second processor 34, and the second BT device 36. Details of operations on establishing the BT connection between the above mentioned electronic devices will be provided in FIG. 4.

FIG. 4 is a flowchart of the second embodiment of a method for establishing the BT connection between the first electronic devices 1 and the second electronic device 3 of FIG. 3.

In block S20, the first processor 14 acquires an address of the first BT device 16 of the first electronic device 1.

In block S22, the first electronic device 1 establishes a connection with the stylus 2 using the first RFID reader 18 and the RFID tag 24.

In block S24, the processor 14 writes the address of the first BT device 16 into the RFID tag 24 of the stylus 2.

In block S26, the second electronic device 3 establishes a connection with the stylus 2 using the second RFID reader 38 and the RFID tag 24.

In block S28, the second RFID reader 38 reads the address of the first BT device 16 from the RFID tag 24 of the stylus 2.

In block S30, the second electronic device 3 establishes a BT connection with the first electronic device 1 using the second BT device 36 and the first BT device 16 according to the address of the first BT device 16.

By utilizing the above embodiments as shown in FIG. 2 and FIG. 4, the second electronic device 3 may acquire the address of the first BT device 16 conveniently using the stylus 2 to transmit the address.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method for establishing a Bluetooth (BT) connection between a first electronic device and a second electronic device, the first electronic device comprising a first BT device, a first infrared device, and a stylus, the second electronic device comprising a second BT device and a second infrared device, the stylus comprising a third infrared device and a storage, the method comprising:
acquiring an address of the first BT device of the first electronic device;
establishing an infrared connection between the first electronic device and the stylus using the first infrared device and the third infrared device;
writing the address of the first BT device into the storage of the stylus;
establishing an infrared connection between the stylus and the second electronic device using the third infrared device and the second infrared device;
reading the address of the first BT device by the second electronic device from the storage of the stylus; and
establishing a BT connection between the second electronic device and the first electronic device using the second BT device according to the address of the first BT device.

2. The method according to claim 1, wherein the storage of the stylus is a register.

3. The method according to claim 1, wherein the first electronic device and the second electronic device are mobile phones, personal digital assistants, or portable computers.

4. A method for establishing a Bluetooth (BT) connection between a first electronic device and a second electronic device, the first electronic device comprising a first BT device, a first radio frequency identification (RFID) reader, and a stylus, the second electronic device comprising a second BT device and a second RFID reader, the stylus comprising a RFID tag, the method comprising:
acquiring an address of the first BT device of the first electronic device;
establishing a connection between the first electronic device and the stylus using the first RFID reader and the RFID tag;
writing the address of the first BT device into the RFID tag of the stylus using the first RFID reader;
establishing a connection between the stylus and the second electronic device using the second RFID reader and the RFID tag;
reading the address of the first BT device by the second RFID reader from the RFID tag of the stylus; and
establishing a BT connection between the second electronic device and the first electronic device using the second BT device according to the address of the first BT device.

5. The method according to claim 4, wherein the first electronic device and the second electronic device are mobile phones, personal digital assistants, or portable computers.

6. A storage medium storing a set of instructions, the set of instructions capable of being executed by a processor to perform a method for establishing a Bluetooth (BT) connection between a first electronic device and a second electronic device, the first electronic device comprising a first BT device, a first radio frequency identification (RFID) reader, and a stylus, the second electronic device comprising a second BT device and a second RFID reader, the stylus comprising a RFID tag, the method comprising:
acquiring an address of the first BT device of the first electronic device;
establishing a connection between the first electronic device and the stylus using the first RFID reader and the RFID tag;
writing the address of the first BT device into the RFID tag of the stylus using the first RFID reader;
establishing a connection between the stylus and the second electronic device using the second RFID reader and the RFID tag;
reading the address of the first BT device by the second RFID reader from the RFID tag of the stylus; and
establishing a BT connection between the second electronic device and the first electronic device using the second BT device according to the address of the first BT device.

7. The storage medium as claimed in claim 6, wherein the first electronic device and the second electronic device are mobile phones, personal digital assistants, or portable computers.
